(19) United States
(12) Patent Application Publication
(10) Pub. No.: US 2007/0271810 A1
(43) Pub. Date: Nov. 29, 2007

(54) Solar augmented clothes dryer

(76) Inventors: Archie Parmelee Kelley, (US); Carol Louise Kelley, (US)

Correspondence Address: ARCHIE P. KELLEY, 18526 E. AMARADO CIRCLE, RIO VERDE, AZ, 85263-5027, US

(21) Appl. No.: 11/805,649

(22) Filed: May 23, 2007

Related U.S. Application Data
(63) Continuation of application No. 60/808,520, filed on May 26, 2006.

(51) Int. Cl. F26B 19/00

(52) U.S. Cl. 34/93

(57) ABSTRACT

This invention decreases the energy consumption of electric or gas combustion clothes dryer appliances by providing solar energy input to the dryer from a roof or exterior wall mounted solar air heater. Required modifications to conventional dryers consist of eliminating the input of laundry room air and providing a new solar heated air supply. As applied to electrically heated clothes dryers, the invention has a potential to reduce the peak electrical utility loads during the summer months since the optimum time to operate the dryer system coincides with the peak load time of the local utility.

### BACKGROUND OF THE INVENTION

This invention relates to the improvement of conventional household electric or gas clothes dryers primarily by utilizing solar energy to reduce the electrical or gas energy required to dry clothes and secondarily, during ambient weather requiring dwelling air-conditioning, by elimination of the air-conditioning penalty of conventional clothes dryers installed in air-conditioned spaces. In addition, for low ambient conditions, this invention makes use of the regeneration of heat energy between the higher temperature exhaust of the dryer to the lower temperature intake of the dryer.

Typical state of the art clothes dryers heat the air drawn into the cabinet of the appliance by electrical resistance heaters in the case of electrical appliances or by combustible gas in the case of gas clothes dryers. Both types of dryers cycle the heated air on and off to maintain an optimum drying temperature for the type of clothing selected by the operator. Both types of dryers also intake air through louvers or other openings in the cabinet of the appliance and discharge the heated drying air by means of a blower in the cabinet to a duct to the roof or outside of the dwelling.

Since dryers are typically installed in air conditioned spaces in residences, the air consumed by the dryer has an air conditioning energy penalty associated with its use during the summer season.

It is an object of this invention to reduce or eliminate, under favorable solar insolation, the electrical or gas energy required to dry clothes. A second object of this invention is to eliminate, during the summer season, the additional energy penalty of conventional dryers caused by the consumption of air-conditioned air.

This penalty consists of two components. First, the air discharged by conventional dryers must be replaced by leakage of outside ambient air into the dwelling. This inleakage air adds to the cooling burden of the air conditioner. Second, since the energy required to heat air is directly proportional to the temperature rise, the required heating of the air conditioned air taken into conventional dryers is greater than the heating required by this invention which utilizes outside ambient air for input to the dryer.

Because of the high (typically several kilowatts) connected power of electrical clothes dryers and the large numbers of these appliances in service, it is a third object of this invention to reduce the peak loads of electrical utilities during the summer months.

Although the title of the invention suggests a single appliance, it will become evident when reviewing the description and the drawings that the invention is a system of several components which function together with the modified dryer to achieve the claimed energy savings.

### BRIEF SUMMARY OF THE INVENTION

A conventional household clothes dryer with either electric resistance or gas heat is modified to seal all of the air intake louvres and all other sources of air leakage into the cabinet. A new circular air intake port is provided to the inlet plenum of the cabinet with a size chosen to duplicate the inflow pressure drop of the louvre system. An insulated duct meeting local building codes is provided to match the air intake port. This duct is installed in a wall adjacent to the clothes dryer and run to the discharge elbow of the solar air heater which may be located on the roof or a sun exposed side wall of the dwelling. If excessive pressure drop is involved in the inlet duct from the solar air heater, an in line blower may be added together with a dust filter.

The solar air heater is designed with sufficient area exposed to the sun to provide a useful augmentation of the existing conventional heating system of the dryer. It will be understood by those familiar with solar heaters that the required area exposed to the sun will vary with the climate, season, and seasonal insolation in the geographic location of the device. In addition, the efficiency of the solar air heater will be affected by its positioning or mounting to optimize the duration of the useful heat input during available sunlight. Optionally, at additional expense, the solar air heater may utilize automatic motorized tracking of the sun to increase the time duration of the heat input.

Depending upon the foregoing variables, the solar air heater may provide a fraction or, on occasion, all of the heat necessary for drying clothes.

In accordance with a further aspect of the invention the dryer control system is modified to provide a “solar” mode of operation as well as an automatic mode. In the automatic mode the dryer uses its conventional control system to supplement the heat energy that may be available from the solar heated inlet. In the solar mode all of the heat energy necessary to dry the clothes will come from the solar air heater and this mode will produce the maximum savings in energy as well as the maximum reduction in the peak load of the affected electrical utility. It is expected that if this invention is utilized widely, the utilities may offer an incentive to customers who will agree to use the solar mode during periods of peak power demand.

In order to understand the invention, attention is invited to the following description of a preferred embodiment of the invention and the accompanying drawing.

### BRIEF DESCRIPTION OF THE VIEWS OF THE DRAWING

FIG. 1 is a schematic representation of the entire assemblage of components of the invention as they would be arranged in a typical dwelling.

### DETAILED DESCRIPTION OF THE INVENTION

While the energy savings achievable by this invention will apply to either an electrical resistance heated dryer system or a gas combustion dryer system, the critically important reduction of peak loads of the associated electrical utility during the summer air conditioning season make the electrical system the preferred embodiment by the inventors. Nevertheless, the differences between the two embodiments are relatively minor and will be apparent upon reviewing the drawing.

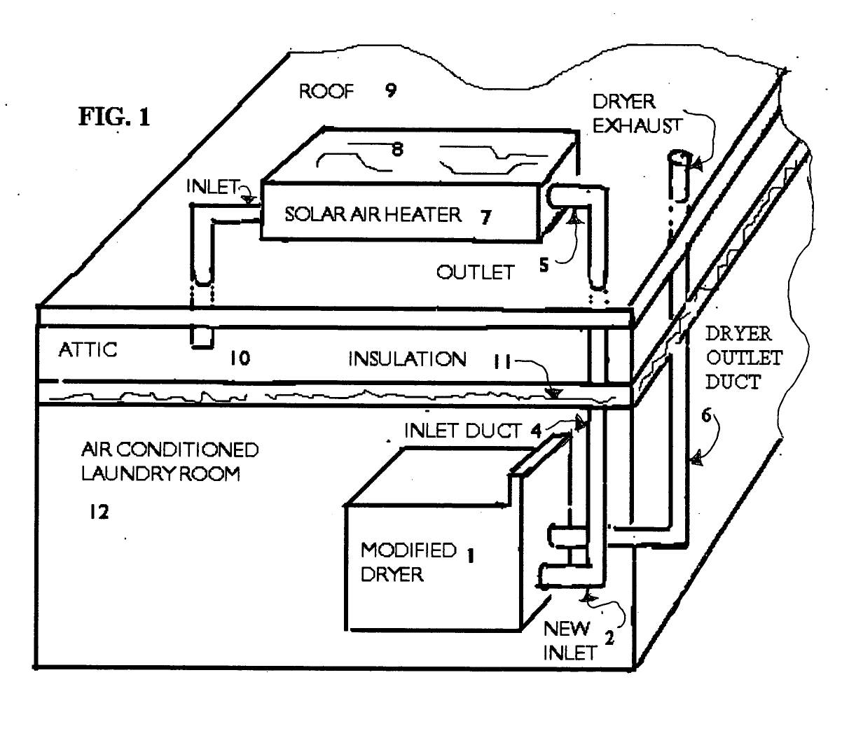

Referring now to the drawing and to FIG. 1 therefore, the solar augmented clothes dryer system includes a clothes dryer appliance 1 modified and improved to enhance the energy saving goals of this invention. It is essential to the functioning of this invention to eliminate the normal room air inflow to the cabinet of 1. This is achieved by eliminating the louvers provided usually in the back of conventional cabinets and, in addition, sealing all other leaks in cabinet sheet metal seams and holes.

With the cabinet sealed, a new inlet port 2 is provided in the rear panel of the cabinet. This inlet port 2 replaces the need for the conventional air inlet louvers in the cabinet. This port is positioned to provide uniform air flow to the electrical resistance heaters at the dryer drum inlet. The size of the inlet port 2 and the inlet ducting 4 is selected to minimize the pressure drop associated with the length and configuration of the ducting 4 as it is installed to connect with the output elbow 5 of the solar air heater 7. As an alternative, in the event that excessive flow pressure loss is encountered in the installation of inlet ducting 4, an in-line blower may be provided. The inlet ducting 4 is insulated to minimize loss of heat from the solar air heater.

In the simplest configuration of the invention, the outlet port and exhaust duct 6 from cabinet 1 are unchanged from conventional dryer design. The appliance blower exhausts the heated air from the cabinet 1 through duct 6 to a vent opening in the roof or a side wall of the dwelling.

As an alternative of this invention, the uninsulated dryer exhaust ducting 6 may be placed co-axially inside the insulated inlet ducting 4 to provide regenerative heat transfer from the dryer exhaust ducting to the inlet ducting. This alternative may be desirable in climates that have low solar insolation, since the temperature of the exhaust from the dryer will usually be higher than the temperature at the intake of the dryer. This wasted heat can be partially recovered in heating the intake air.

Referring again to FIG. 1 the solar air heater 7 is placed on the roof of the dwelling in this example. Alternatively, it may be placed on a sun oriented side of a dwelling. The solar air heater 7 consists of a metal box frame with a flat or corrugated metal plate in the box bottom with a highly absorbent black finish in accordance with current solar collector practice. The external surface of the box is also finished to maximize the solar heat energy absorbed by the air heater. The box is closed on the sun exposed side 8 by a transparent glass or plastic cover with materials selected to maximize the amount of the sun's energy entering the box.

Alternatively, the transparent sheet covering the solar air heater may include multiple lenses to increase the intensity of solar insolation. The inventors understand that this technology is currently being considered to increase the efficiency of photovoltaic solar panels and we believe it could apply to the solar air heater of this invention as an alternate when utilized in conditions of low solar insolation.

The inlet air to the solar air heater may be taken directly from the roof of the dwelling 9 or alternatively from the attic space 10 immediately below the roof of the dwelling but above the thermal insulation 11 which is normally placed above the ceiling of the living space below the attic 12. The area 8 of the solar air heater exposed to the sun is determined by the average insolation during the expected operating period of the clothes dryer and the desired input temperature to the clothes dryer. However, it will be noted that even modest heating of the inlet air will produce savings in energy since the electrical resistance heaters will cycle “on” less frequently with any additional input of heat from the solar air heater.

It will be recognized that the energy required by the drum drive motor and the blowers of the system are a small fraction of the energy required by the one or several electric resistance heaters of conventional designs. Thus, the operator may accept a longer drying time in return for a useful energy saving.

Referring now to FIG. 1 item 1, it will be evident that conventional electric clothes dryers draw the intake air through multiple louvers usually in the back panel of the appliances. The suction to provide this direction of flow is provided by the intake of the dryer's blower located in the cabinet at the exit of the dryer drum and lint filter. The incoming air from the laundry room is conditioned by the dwelling heating, ventilation and cooling system. Since this air is ultimately discharged to the outside of the dwelling, it represents an energy loss, either heating or cooling, that must be made up for the replacement in leakage of air in the dwelling. Eliminating this loss is, in addition to the reduction of electrical heater energy consumption, a benefit of this invention.

This invention utilizes the conventional dryer controls to permit the user to choose the level of drying for the several types of clothing which may have different temperature requirements. As with conventional dryers, at the beginning of the cycle with moist or wet clothes in the dryer drum of this invention, the exit temperature from the drum will be cool because of the evaporative heat loss from the clothing. At the end of the drying cycle, the exit temperature from the drum will rise to approach the drum inlet temperature and this will indicate that most or all of the moisture has been removed from the clothing load. If the dryer is in the automatic mode it will shut off at this point. None of these features of conventional dryers are changed by this invention and the operator will find the operation of the modified dryer of this invention to be completely familiar, with the exception of the “solar” mode of operation discussed below.

To permit a distinct “solar” mode of operation in which the electrical or gas heat of the conventional appliance is de-energized, a switch in the “start” circuitry is installed in this invention to permit operation with a minimum use of electrical or gas energy. This mode may be desirable under conditions of high solar insolation or when the local electrical utility provides incentives to the consumer to reduce his connected load under conditions of peak power demand.

The inventors anticipate that normal operation of dryers incorporating this invention will be in the automatic mode and the “solar only” mode will be used to provide the absolute minimum consumption of power or to meet the local utility's incentive to limit peak power demand. It should be noted that under maximum conditions of solar heat input in areas such as the Sonoran desert of the southwest United States or the deserts of the southern Mediterranean or the African continent, the electrical resistance heaters may not cycle “on” even with the control system set in the automatic mode. Thus operators of the solar augmented clothes dryer will find that they need no special training or knowledge of the characteristics of the appliance.

Referring now to FIG. 1 detail 1 this invention substantially modifies the inlet flow to the dryer in that the inlet louver system must be completely sealed, as well as any leakage into the cabinet from sheet metal joints, door seals, etc. This modification is necessary to insure that the inlet air to the dryer will be drawn in from the external solar air heater system rather than the laundry room. The conventional intake system is replaced by a single large diameter port 2 cut into the rear or sides of the cabinet 1.

This port is connected to the duct system from the externally mounted solar air heater and is located to match the internal flow of the conventional dryer.

The appliance blower in cabinet 1 exhausts the heated air following its drying flow through the appliance drum through the exhaust duct 6 to a vent opening on the roof or sidewall of the dwelling.

We claim:

1. A method of drying clothes comprising a conventional clothes dryer appliance modified (sealed) to prevent the customary intake of air from the laundry room or space in which the dryer is located with means to supply intake air to the dryer directly from the ambient air external to the dwelling, and means to exhaust the drying air from the dryer to the ambient external to the dwelling.

2. The combination of claim 1 with means to take the input air to the dryer from an attic or other naturally heated space under the roof structure or adjacent to sun exposed walls of the dwelling.

3. The combination of claims 1 and 2 with means to further heat the input air to the dryer with a solar air heater mounted in a sun exposed area on the roof or sun oriented walls of the dwelling.

4. Means to provide an optional “solar only” operator control mode in which the electrical or gas combustion heating system of the dryer is inactivated. This mode is in addition to retaining the conventional drying modes in which the system of this invention will augment the conventional heaters in the dryer.

5. An optional regenerative clothes dryer ducting system in which the normally higher temperature exhaust duct from the dryer is contained co-axially inside an insulated larger diameter duct which contains normally cooler inflowing air to the dryer. The two ducts are separated at each end of the system by a plenum to allow the ducts to diverge or converge from and to the combined regenerative duct system.

6. A solar air heater comprised of a metal or plastic housing structure sized to provide the desired temperature input to the modified and improved dryer of claim 1. The sun-facing surface of the heater has a clear glass or plastic cover sized to admit sufficient solar energy for the climate and insolation of the location in which it is installed. The solar heat is captured in the inside bottom of the structure by a metallic plate that is corrugated to increase heat transfer surface area to the air flowing in the heater. The entire structure except for the transparent glass or plastic cover is finished with known low albedo, solar absorbent paint sometimes known as “solar black”.

7. The combination of claim 6 wherein the solar air heater transparent cover contains multiple lenses to increase the temperature of the heat absorbing surface inside the heater.

8. The combination of claim 6 wherein an air blower is attached to the inlet nozzle of the solar air heater to improve flow in cases where the pressure drop to the modified clothes dryer may be excessive.
